(19) United States
(12) Patent Application Publication
(10) Pub. No.: US 2006/0221005 A1
(43) Pub. Date: Oct. 5, 2006

(54) DISPLAY, ARRAY SUBSTRATE, AND METHOD OF DRIVING DISPLAY

(76) Inventors: Kazuyoshi OMATA, Fukaya-shi (JP); Makoto Shibusawa, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/277,273

(22) Filed: Mar. 23, 2006

(30) Foreign Application Priority Data
Mar. 31, 2005 (JP) 2005-105097

(51) Int. Cl. G09G 3/30

(52) U.S. Cl. 345/76

(57) ABSTRACT

Each pixel of a display includes a drive control element including first and second terminals and a control terminal, a display element including first and second electrodes and an active layer interposed therebetween, an output control switch connected between the second terminal and the first electrode, a switch group capable of switching between a state that the second terminal, the control terminal, and a video signal line are connected to one another and a state that they are disconnected from one another, first to third capacitors, and first to third switches. The first switch, the first capacitor, the second switch, and the second capacitor are connected in series between the control terminal and a constant-potential terminal in this order. The third switch and the third capacitor are connected in series between the control terminal and an electrode of the second capacitor to which the second switch is connected.

### CROSS-REFERENCE TO RELATED APPLICATIONS

This application is based upon and claims the benefit of priority from prior Japanese Patent Application No. 2005-105097, filed Mar. 31, 2005, the entire contents of which are incorporated herein by reference.

### BACKGROUND OF THE INVENTION

1. Field of the Invention

The present invention relates to a display, an array substrate, and a method of driving a display.

2. Description of the Related Art

On a display such as organic electroluminescent (EL) display that controls optical characteristics of each display element by magnitude of a drive current passed through the display element, image quality deterioration such as luminance unevenness occurs if magnitudes of the drive currents vary. Therefore, when an active matrix driving method is used in this display, the pixels must be the same in characteristics of a drive control element for controlling the magnitude of the drive current. In this display, however, the drive control elements are normally formed on an insulator such as glass substrate, so the characteristics of them easily vary.

U.S. Pat. No. 6,373,454 describes an organic EL display using a current mirror circuit in a pixel.

This pixel includes an n-channel field-effect transistor as the drive control element, organic EL element, and capacitor. The source of the n-channel field-effect transistor is connected to a power supply line at a lower electric potential, and the capacitor is connected between the gate of the n-channel field-effect transistor and the power supply line. The anode of the organic EL element is connected to a power supply line at a higher electric potential.

The pixel circuit is driven as described below.

Firstly, the drain of the n-channel field-effect transistor is connected to its gate. A current I_{sig} at magnitude corresponding to a video signal is made to flow between the drain and source of the n-channel field-effect transistor. This operation sets the voltage between electrodes of the capacitor, equal to a gate-to-source voltage necessary for the n-channel field-effect transistor to pass the current I_{sig} through its channel.

Then, the gate of the n-channel field-effect transistor is disconnected from its drain, and the voltage between the electrodes of the capacitor is maintained. The drain of the n-channel field-effect transistor is subsequently connected to the cathode of the organic EL element. This allows a drive current I_{drv} to flow through the organic EL element at magnitude almost equal to that of the current I_{sig}. The organic EL element emits light at a luminance corresponding to the magnitude of the drive current I_{drv}.

The above configuration makes it possible for the drive current I_{drv}, which flows between the drain and source of the n-channel field-effect transistor during a retention period following a write period, to have magnitude almost equal to that of the current I_{sig} supplied as a video signal during the write period. Therefore, the influence of not only the threshold value Vₜₕ but also the mobility, dimensions, and the like of the n-channel field-effect transistor on the drive current I_{drv} can be eliminated.

However, it is difficult for the display to write a video signal V_{sig} corresponding to a small drive current I_{drv}. Therefore, on this display, it is difficult to display each gray level within a low gray level range with a high degree of reproducibility.

### BRIEF SUMMARY OF THE INVENTION

According to a first aspect of the present invention, there is provided a display comprising pixels arranged in a matrix, and video signal lines arranged correspondently with columns which the pixels form, each of the pixels comprising a drive control element which includes a control terminal, a first terminal connected to a first power supply terminal, and a second terminal outputting a current at a magnitude corresponding to a voltage between the control terminal and the first terminal, a display element which includes a first electrode, a second electrode connected to a second power supply terminal, and an active layer interposed between the first and second electrodes, an output control switch connected between the second terminal and the first electrode, a switch group which is capable of switching between a first state that the second terminal, the control terminal, and the video signal line are connected to one another and a second state that the second terminal, the control terminal, and the video signal line are disconnected from one another, first to third capacitors, and first to third switches, the first switch, the first capacitor, the second switch, and the second capacitor being connected in series between the control terminal and a constant-potential terminal in this order, and the third switch and the third capacitor being connected in series between the control terminal and an electrode of the second capacitor to which the second switch is connected.

According to a second aspect of the present invention, there is provided an array substrate comprising pixel circuits arranged in a matrix, and video signal lines arranged correspondently with columns which the pixel circuits form, each of the pixel circuits comprising a drive control element which includes a control terminal, a first terminal connected to a power supply terminal, and a second terminal outputting a current at a magnitude corresponding to a voltage between the control terminal and the first terminal, a pixel electrode, an output control switch connected between the second terminal and the pixel electrode, a switch group which is capable of switching between a first state that the second terminal, the control terminal, and the video signal line are connected to one another and a second state that the second terminal, the control terminal, and the video signal line are disconnected from one another first to third capacitors, and first to third switches, the first switch, the first capacitor, the second switch, and the second capacitor being connected in series between the control terminal and a constant-potential terminal in this order, and the third switch and the third capacitor being connected in series between the control terminal and an electrode of the second capacitor to which the second switch is connected.

According to a third aspect of the present invention, there is provided a method of driving the display according to the first aspect, comprising sequentially selecting rows which the pixels form, sequentially executing first and second write operations on each of the pixels included in the selected row, and executing a display operation on each of the pixels included in the non-selected row.

### BRIEF DESCRIPTION OF THE SEVERAL VIEWS OF THE DRAWING

FIG. 1 is a plan view schematically showing a display according to the first embodiment of the present invention;

FIG. 2 is a sectional view schematically showing an example of a structure that can be used in the display shown in FIG. 1;

FIG. 3 is an equivalent circuit diagram showing a pixel included in the display shown in FIG. 1;

FIG. 4 is a timing chart schematically showing an example of a method of driving the display shown in FIG. 1;

FIG. 5 is a plan view schematically showing a display according to the second embodiment of the present invention;

FIG. 6 is an equivalent circuit diagram of a pixel included in the display shown in FIG. 5; and

FIG. 7 is a timing chart schematically showing an example of a method of driving the display shown in FIG. 5.

### DETAILED DESCRIPTION OF THE INVENTION

Embodiments of the present invention will be described below in detail with reference to the drawings. In the drawings, components having similar functions are denoted by the same reference numerals and duplicate descriptions will be omitted.

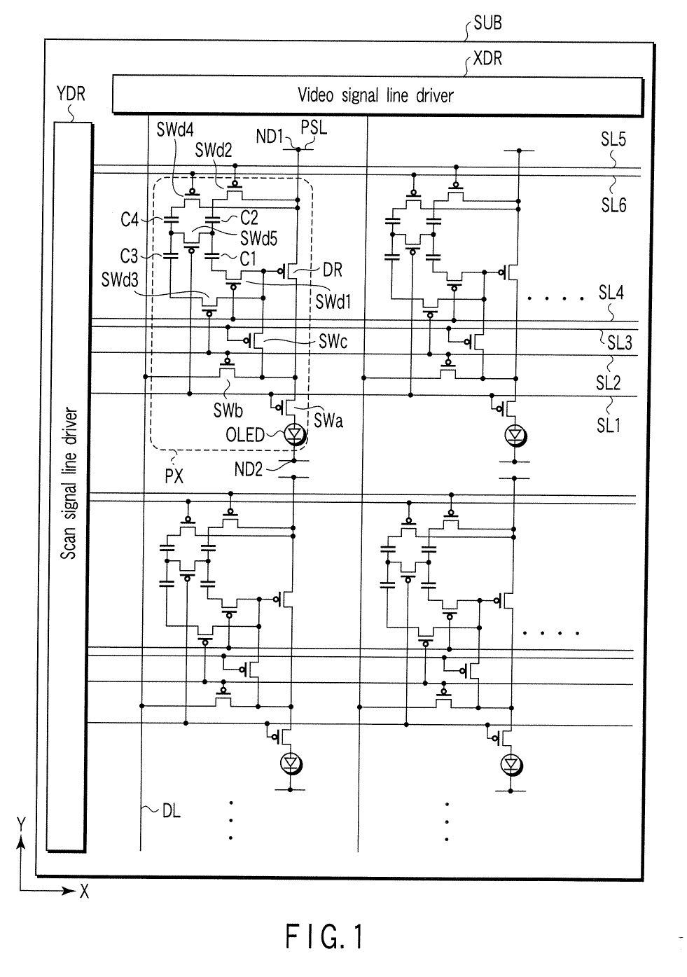

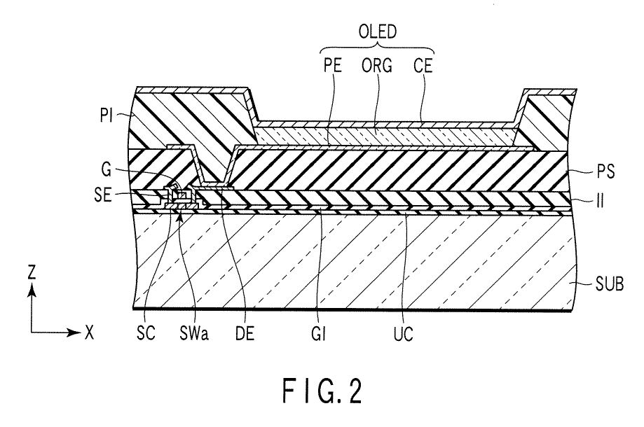

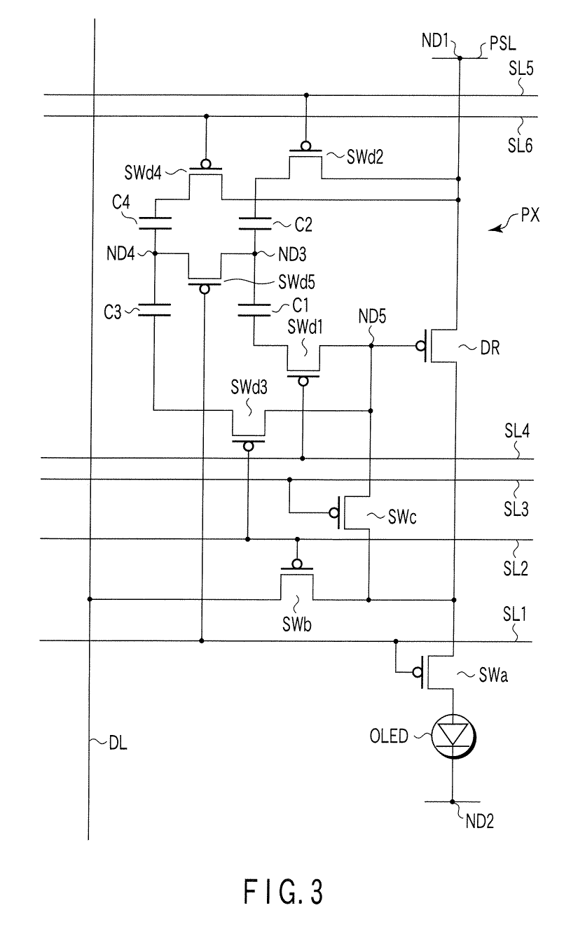

FIG. 1 is a plan view schematically showing a display according to the first embodiment of the present invention. FIG. 2 is a sectional view schematically showing an example of a structure that can be used in the display shown in FIG. 1. FIG. 3 is an equivalent circuit diagram showing a pixel included in the display shown in FIG. 1. In FIG. 2, the display is drawn so that its display surface, that is, its front surface or light emitting surface faces the bottom of the drawing, while its back surface faces the top of the drawing.

This display is a bottom emission organic EL display that employs an active matrix driving method. The organic EL display includes an insulating substrate SUB such as glass substrate.

For example, an SiNₓ layer and an SiOₓ layer are sequentially stacked on the substrate SUB as an undercoat layer UC shown in FIG. 2.

Semiconductor layers SC such as polysilicon layers are arranged on the undercoat layer UC. Source and drain are formed in each polysilicon layer SC.

The undercoat layer UC and semiconductor layers SC are covered with a gate insulator GI. The gate insulator GI can be made from tetraethyl orthosilicate (TEOS), for example.

Gates G are arranged on the gate insulator GI. The gates G are made of MoW, for example.

The semiconductor layers SC, gate insulator GI, and gates G form top-gate type thin-film transistors. In the present embodiment, the thin-film transistors are utilized as drive control elements DR, switches SWa to SWc, and switches SWd1 to SWd5 included in pixels PX shown in FIGS. 1 and 3.

On the gate insulator GI, bottom electrodes of capacitors C1 to C4 and scan signal lines SL1 to SL6 shown in FIGS. 1 and 3 are further arranged. These components can be formed in the same process as that for forming the gates G.

As shown in FIG. 1, the scan signal lines SL1 to SL6 extend along the rows of the pixels PX, i.e., in an X direction, and are arranged in a Y direction along the columns of the pixels PX. The scan signal lines SL1 to SL6 are connected to a scan signal line driver YDR.

An interlayer insulating film II shown in FIG. 2 covers the gate insulator GI, gates G, scan signal lines SL1 to SL6, and top electrodes of the capacitors C1 to C4. The interlayer insulating film II is, for example, an SiOₓ film formed by plasma CVD. Parts of the interlayer insulating film II are utilized as dielectric layers of the capacitors C1 to C4.

On the interlayer insulating film II, top electrodes of the capacitors C1 to C4 shown in FIGS. 1 and 3, source electrodes SE and drain electrodes DE shown in FIG. 2, and video signal lines DL and power supply lines PSL shown in FIGS. 1 and 3 are arranged. These components can be formed in the same process and may have a three-layer structure of, for example, Mo, Al, and Mo.

The source electrodes SE and drain electrodes DE are electrically connected to the sources and drains of the thin-film transistors via contact holes formed in the interlayer insulting film II.

As shown in FIG. 1, the video signal lines DL extend in the Y direction and are arranged in the X direction. The video signal lines DL are connected to a video signal line driver XDR.

The power supply lines PSL extend in the Y direction and are arranged in the X direction, for example.

A passivation film PS shown in FIG. 2 covers the source electrodes SE, drain electrodes DE, video signal lines DL, power supply lines PSL, and top electrodes of the capacitors C1 to C4. The passivation film PS is made of, for example, SiNₓ.

As shown in FIG. 2, first electrodes PE as pixel electrodes are arranged on the passivation film PS. In the present embodiment, the first electrodes PE are light-transmissible front electrodes. Each first electrode PE is connected through a through-hole formed in the passivation film PS to the drain electrode DE to which the drain of the switch SWa is connected.

In this embodiment, the first electrodes PE are anodes. A transparent conductive oxide, for example, indium tin oxide (ITO) can be used as a material of the first electrodes PE.

A partition insulating layer PI shown in FIG. 2 is further placed on the passivation film PS. The partition insulating layer PI has through-holes formed at positions corresponding to the first electrodes PE or slits formed at positions corresponding to columns or rows formed by the first electrodes PE. Here, by way of example, the partition insulating layer PI has through-holes formed at positions corresponding to the first electrodes PE.

The partition insulating layer PI is, for example, an organic insulating layer. The partition insulating layer PI can be formed using, for example, a photolithography technique.

An organic layer ORG as an active layer including an emitting layer is placed on each of the first electrodes PE. The emitting layer is, for example, a thin film containing a luminescent organic compound that emits red, green, or blue light. In addition to the emitting layer, the organic layer ORG may include a hole injection layer, a hole transporting layer, a hole blocking layer, an electron transporting layer, and an electron injection layer.

The partition insulating layer PI and the organic layer ORG are covered with a second electrode CE as a counter electrode. The second electrode CE is a common electrode shared among the pixels PX. In this embodiment, the second electrode CE is a light-reflective cathode serving as a back electrode. For example, an electrode wire (not shown) is formed on the layer on which the video signal lines DL are formed, and the second electrode CE is electrically connected to the electrode wire via a contact hole formed in the passivation film PS and partition insulating layer PI. Each organic EL element OLED includes the first electrode PE, organic layer ORG, and second electrode CE.

Each pixel PX includes an organic EL element OLED and pixel circuit. In the present embodiment, the pixel circuit includes the drive control element DR, output control switch SWa, selector switch SWb, diode-connecting switch SWc, switches SWd1 to SWd5, and capacitors C1 to C4 as shown in FIGS. 1 and 3. As described above, in the present embodiment, the drive control element DR and switches SWa to SWc and SWd1 to SWd5 are p-channel thin-film transistors. The switches SWa to SWc and SWd1 to SWd5 form a switch group, and the capacitors C1 to C4 form a capacitor group.

The drive control element DR, output control switch SWa, and organic EL element OLED are connected in series between a first power supply terminal ND1 and second power supply terminal ND2 in this order. In this embodiment, the first power supply terminal ND1 is a high-potential power supply terminal, and the second power supply terminal ND2 is a low-potential power supply terminal. Further, in this embodiment, the source, drain and gate of the drive control element DR correspond to the first, second and control terminals, respectively.

The gate of the output control switch SWa is connected to the scan signal line SL1. The selector switch SWb is connected between the video signal line DL ad the drain of the drive control element DR. The gate of the switch SWb is connected to the scan signal line SL2. The diode-connecting switch SWc is connected between the drain and gate of the drive control element DR. The gate of the switch SWc is connected to the scan signal line SL2. The selector switch SWb and diode-connecting switch SWc form a switch group which can switch between a first state that the drain and gate of the drive control element DR and the video signal line are connected to one another and a second state that they are disconnected from one another.

The switch SWd1 and capacitor C1 are connected in series between the gate of the drive control element DR and a node ND3 as a third terminal in this order. The gate of the switch SWd1 is connected to the scan signal line SL4.

The switch SWd2 and capacitor C2 are connected in series between the first power supply terminal Nd1 as a constant-potential terminal and the node ND3. As an example, the switch SWd2 and capacitor C2 are connected in series between the first power supply terminal and the node ND3 in this order. The gate of the switch SWd2 is connected to the scan signal line SL5.

The switch SWd3 and capacitor C3 are connected in series between the gate of the drive control element DR and a node ND4 ad a fourth terminal. As an example the switch SWd3 and capacitor C3 are connected in series between the gate of the drive control element DR and the node ND4 in this order. The gate of the switch SWd3 is connected to the scan signal line SL2.

The switch SWd4 and capacitor C4 are connected in series between the first power supply terminal ND1 and the node ND4. As an example, the switch SWd4 and capacitor C4 are connected in series between the first power supply terminal ND1 and the node ND4 in this order. The gate of the switch SWd4 is connected to the scan signal line SL6.

The switch SWd5 is connected between the nodes ND3 and ND4. The gate of the switch SWd5 is connected to the scan signal line SL1.

The organic EL display is driven by, for the example, the method described below.

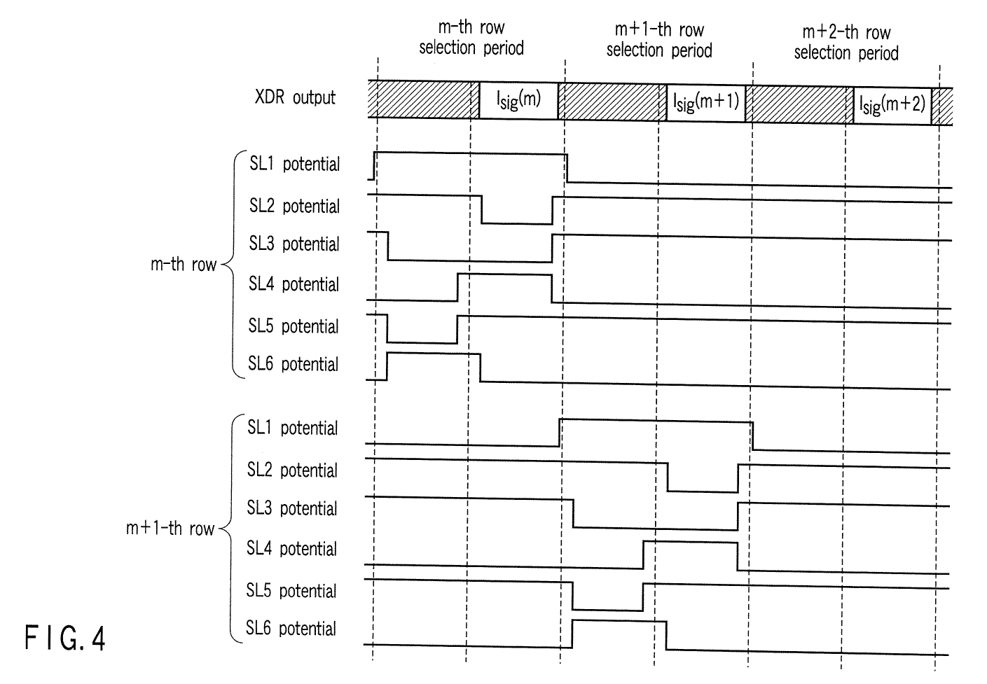

FIG. 4 is a timing chart schematically showing an example of a method of driving the display shown in FIG. 1.

In FIG. 4, the abscissa indicates time, while the ordinate indicates potential. As for the “XDR output” in FIG. 4, during the period shown as “I_{sig}(m+M)”, the video signal line driver XDR outputs a video signal I_{sig}(m+M) to the video signal line DL. In FIG. 4, the waveforms shown as “VSL1 potential” to “SL6 potential” represent the potentials of the scan signal lines SL1 to SL6, respectively.

According to the method shown in FIG. 4, the display shown in FIG. 1 is driven in the manner described below. For simplification, it is assumed that the capacitors C1 and C3 are equal in capacitance, and the capacitors C2 and C4 are equal in capacitance.

According to the method shown in FIG. 4, the rows of the pixels PX are selected sequentially. First and second write operations are executed on each pixel PX in the selected row, and a display operation is executed on each pixel PX in the non-selected rows.

When a certain gray level is to be displayed on a pixel PX in the m-th row, during a period over which the pixels PX in the m-th row are selected, that is, during an m-th row selection period, the switch SWa of the selected pixel PX is opened (nonconductive state). During first and second write periods over which the switch SWa is open, the following write operations are executed on the selected pixel PX.

In the first write period, the first write operation is executed. That is, the switches SWc and SWd2 are closed (conductive state), and the switch SWd4 is opened (non-conductive state). The switch SWd1 is kept closed, and the switches SWa, SWb, SWd3 and SWd5 are kept open. After a certain time period has elapsed, the switches SWd1 and SWd2 are opened to terminate the first write period.

The first write operation sets the gate-to-source voltage of the drive control element DR at a value equal to its threshold voltage Vₜₕ. Therefore, letting the potential of the first power supply terminal ND1 be V_{dd}, the capacitances of the capacitors C1 and C3 be Cₐ, and the capacitances of the capacitors C2 and C4 be C_{b}, the potential V₃ of the node ND3 and the potential V₅ of the node ND5 can be expressed as the following equations (1) and (2), respectively. Hence, the voltage between the nodes ND3 and ND5, that is, the voltage VC1 between the electrodes of the capacitor C1 can be expressed as the following equation (3).

$$\begin{matrix}{V}_{3} = {V}_{dd} + \frac{{C}_{b}}{{C}_{a} + {C}_{b}} \times {V}_{th} & ( 1 ) \\ {V}_{5} = {V}_{dd} + {V}_{th} & ( 2 ) \\ {V}_{C 1} = \frac{{C}_{a}}{{C}_{a} + {C}_{b}} \times {V}_{th} & ( 3 )\end{matrix}$$

In the second write period, the second write operation is executed. That is, switches SWb, SWd3 and SWd4 are closed. The switch SWc is kept closed, and the switches SWa, SWd1, SWd2 and SWd5 are kept open. In this state, the video signal line driver XDR outputs a video signal to the video signal line DL. In other words, the video signal line driver XDR makes a write current I_{sig} flow from the first power supply terminal ND1 to the video signal line DL. After a certain time period has elapsed, the switches SWb, SWc and SWd3 are opened to terminate the second write period.

The second write operation sets the difference between the potential V₅ of the node ND5 and the potential V_{dd} of the first power supply terminal ND1 at a value equal to the gate-to-source voltage of the drive control element DR when it allows the write current I_{sig}(m) to flow. Therefore, letting the potential V₅ of the node ND5 be V_{g}(m), the potential V₄ of the node ND4 can be expressed as the following equation (4).

$${V}_{4} = \frac{{C}_{a} \times {V}_{dd} + {C}_{b} \times {V}_{g} ( m )}{{C}_{a} + {C}_{b}} \qquad ( 4 )$$

Letting the channel the width of the drive control element DR be W, its channel length be L, its carrier mobility be μ, and its gate oxide film capacitance be Cₒₓ, the drain current I_{d} of the drive control element DR in the saturation region can be expressed as the following equation (5). And the write current I_{sig}(m) can be expressed as the following equation (6).

$$\begin{matrix}\begin{matrix}{I}_{d} = \frac{1}{2} \times \frac{W}{L} \times μ \times {C}_{OX} \times {( {V}_{5} - {V}_{dd} - {V}_{th} )}^{2} \\ = K \times {( {V}_{5} - {V}_{dd} - {V}_{th} )}^{2}\end{matrix} & ( 5 ) \\ {I}_{sig} ( m ) = K \times {[ {V}_{g} ( m ) - {V}_{dd} - {V}_{th} ]}^{2} & ( 6 )\end{matrix}$$

In the effective display period following the second write period, the switches SWa and SWd5 are closed. The switches SWb, SWc, SWd2 and SWd3 are kept open, and the switches SWd1 and SWd4 are kept closed.

When the switch SWd5 is closed, the potential V₃ of the node ND3 is set equal to the potential V₄ of the node ND4 expressed as the equation (4). Since the capacitor C1 maintains the inter-electrode voltage V_{C1} expressed as the equation (3), the potential V₅ of the node ND5 is set at a value equal to the sum of the potential V₄ expressed as the equation (4) and the inter-electrode voltage V_{C1} expressed as the equation (3). That is, the potential V₅ of the node ND5 can be expressed as the following equation (7). Consequently, during the effective display period, the drive current I_{drv}(m) expressed as the following equation (8) flows through the organic EL element OLED. The organic EL element OLED emits light at luminance corresponding to the magnitude of the drive current I_{drv}(m).

$$\begin{matrix}{V}_{5} = \frac{{C}_{a} \times ( {V}_{dd} + {V}_{th} ) + {C}_{b} \times {V}_{g} ( m )}{{C}_{a} + {C}_{b}} & ( 7 ) \\ {I}_{drv} ( m ) = K \times {( \frac{{C}_{b}}{C a + C b} )}^{2} \times {[ {V}_{g} ( m ) - {V}_{dd} - {V}_{th} ]}^{2} & ( 8 )\end{matrix}$$

A gray level within the low gray level range is displayed by passing a small drive current I_{drv} through the organic EL element OLED. Therefore, when magnitude of the write current I_{sig} is almost equal to that of the drive current I_{drv}, it is necessary to significantly reduce the magnitude of the write current I_{sig} in order to display a gray level within the low gray level range. When the write current I_{sig} is small, it is difficult to set the gate-to-source voltage of the drive control element DR at a value corresponding to the write current I_{sig} in a short time due to the effect of the wiring capacitance of the video signal line DL and the like.

In contrast, according to the driving method described with reference to FIG. 4, as apparent by comparing the equation (6) with the equation (8), the magnitude of the drive current I_{drv} is [C_{b}/(Cₐ+C_{b})]² times the magnitude of the write current I_{sig}. Therefore, when the capacitances Cₐ and C_{b} are set appropriately, a gray level within the low gray level range can be display without significantly reduce the magnitude of the write current I_{sig}. Consequently, according to the present embodiment, each gray level within the low gray level range can be displayed with a high degree of reproducibility.

The capacitances of the capacitors C1 and C3 may be different from each other. Further, the capacitances of the capacitors C2 and C4 may be different from each other. In this case, although the relation between the magnitudes of the drive current I_{drv} and the write current I_{sig} deviates from the proportional relation, substantially the same effect as that described above can be attained.

A reset period may be provided before the write periods. For example, a first reset operation and/or second reset operation described below may be executed prior to the first write operation.

The first reset operation includes closing the switches SWc and SWd2, and opening the switches SWd4 and SWd5. The switches SWa and SWd1 are kept closed, and the switches SWb and SWd3 are kept open. The potential V₅ of the node N5 set by the first reset operation reflects the characteristics of the drive control element DR and organic EL element OLED.

The second reset operation includes opening the switches SWd1 and SWd2, and closing the switches SWd3 and SWd4. The switches SWa and SWc are kept closed, and the switches SWb and SWd5 are kept open. The potential V₅ of the node N5 set by the second reset operation reflects the characteristics of the drive control element DR and organic EL element OLED.

Note that the first reset operation individually controls the switching operation of the switch SWa and the switching operation of the switch SWd5. The second reset operation individually controls the switching operation of the switch SWb and the switching operation of the switch SWd3 in addition to individually control the switching operation of the switch SWa and the switching operation of the SWd5. When such a control is to be executed, additional scan signal lines are necessary.

The second embodiment of the present invention is described below.

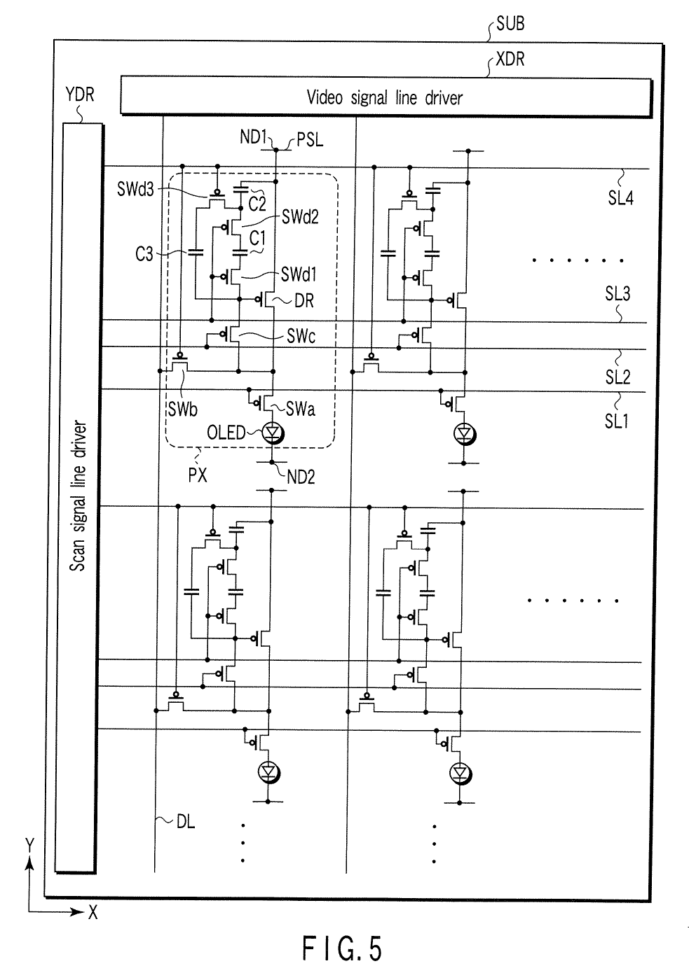

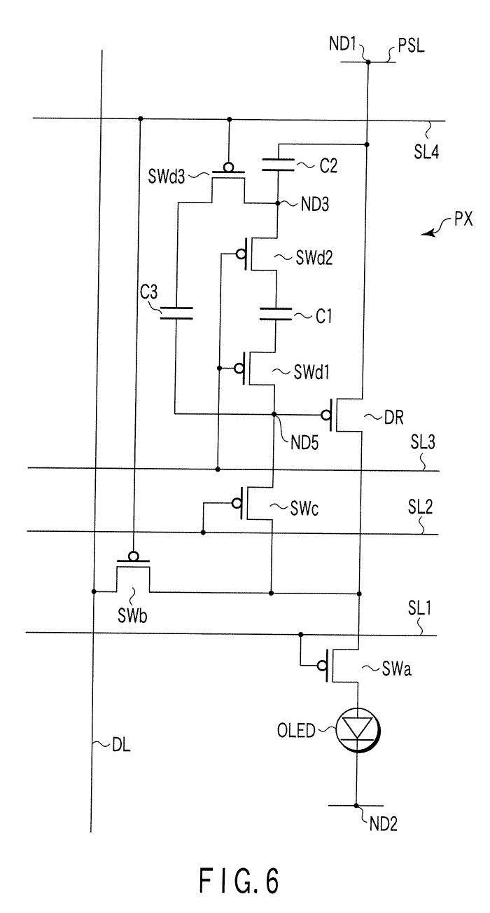

FIG. 5 is a plan view schematically showing a display according to the second embodiment of the present invention. FIG. 6 is an equivalent circuit diagram of a pixel included in the display shown in FIG. 5.

This display is a bottom emission organic EL display that employs an active matrix driving method. The organic EL display has the same structure as that of the organic EL display according to the first embodiment except for the following.

In this organic EL display, the scan signal lines SL5 and SL6 are omitted. Further, each pixel PX includes the organic EL element OLED, drive control element DR, output control switch SWa, selector switch SWb, diode-connecting switch SWc, switches SWd1 to SWd3, and capacitors C1 to C3.

The drive control element DR, output control switch SWa, and organic EL element OLED are connected in series between the first power supply terminal ND1 and second power supply terminal ND2 in this order. The gate of the output control switch SWa is connected to the scan signal line SL1.

The selector switch SWb is connected between the video signal line and the drain of the drive control element DR. The gate of the switch SWb is connected to the scan signal line SL2. The diode-connecting switch SWc is connected between the drain and gate of the drive control element DR. The gate of the switch SWc is connected to the scan signal line SL2.

The switch SWd1, capacitor C1, and switch SWd2 are connected in series between the gate of the drive control element DR and the node ND3 as the third terminal in this order. The gates of the switches SWd1 and SWd2 are connected to the scan signal line SL3.

The capacitor C2 is connected between the first power supply terminal ND1 as the constant-potential terminal and the node ND3.

The capacitor C3 and switch SWd3 are connected in series between the gate of the drive control element DR and the node ND3. As an example, the capacitor C3 and switch SWd3 are connected in series between the gate of the drive control element DR and the node ND3 in this order. The gate of the switch SWd3 is connected to the scan signal line SL4.

The organic EL display is driven by, for the example, the method described below.

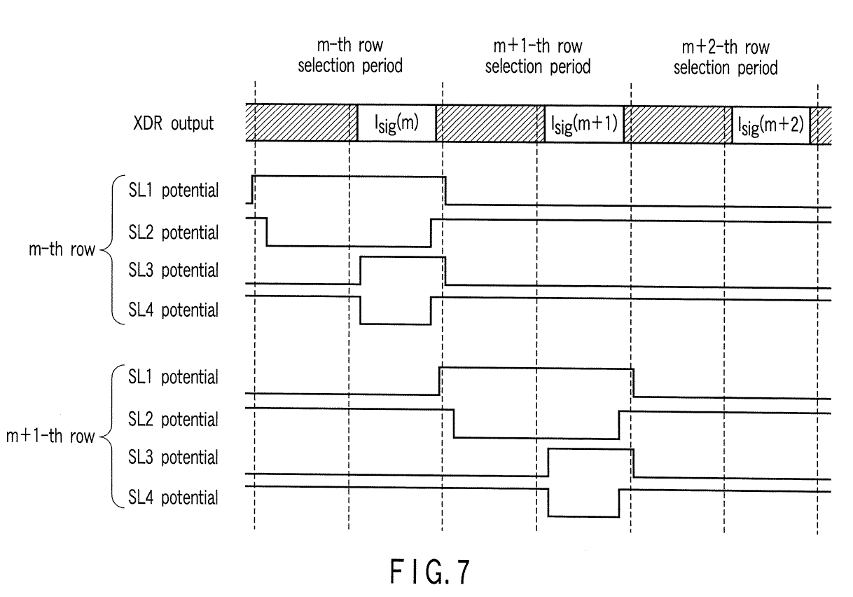

FIG. 7 is a timing chart schematically showing an example of a method of driving the display shown in FIG. 5.

In FIG. 7, the abscissa indicates time, while the ordinate indicates potential. As for the “XDR output” in FIG. 7, during the period shown as “I_{sig}(m+M)”, the video signal line driver XDR outputs a video signal I_{sig}(m+M) to the video signal line DL. In FIG. 7, the waveforms shown as “SL1 potential” to “SL4 potential” represent the potentials of the scan signal lines SL1 to SL4, respectively.

According to the method shown in FIG. 7, the display shown in FIG. 5 is driven in the manner described below. For simplification, it is assumed that the capacitors C1 to C3 are equal in capacitance.

According to the driving method, the rows of the pixels PX are selected sequentially. First and second write operations are executed on each pixel PX in the selected row, and a display operation is executed on each pixel PX in the non-selected rows.

When a certain gray level is to be displayed on a pixel PX in the m-th row, during a period over which the pixels PX in the m-th row are selected, that is, during an m-th row selection period, the switch SWa of the selected pixel PX is opened. During first and second write periods over which the switch SWa is open, the following write operations are executed on the selected pixel PX.

In the first write period, the first write operation is executed. That is, the switch SWc is closed. The switches SWd1 and SWd2 are kept closed, and the switches SWb and SWd3 are kept open. After a certain time period has elapsed, the switches SWd1 and SWd2 are opened to terminate the first write period.

The first write operation sets the gate-to-source voltage of the drive control element DR at a value equal to its threshold voltage Vₜₕ. Therefore, letting the potential of the first power supply terminal ND1 be V_{dd}, the capacitances of the capacitors C1 and C3 be Cₐ, and the capacitance of the capacitor C2 be C_{b}, the potential V₃ of the node ND3 and the potential V₅ of the node ND5 can be expressed as the above equations (1) and (2), respectively. Hence, the voltage between the nodes ND3 and ND5, that is, the voltage V_{C1} between the electrodes of the capacitor C1 can be expressed as the above equation (3).

In the second write period, the second write operation is executed. That is, switches SWb and SWd3 are closed. The switch SWc is kept closed, and the switches SWa, SWd1 and SWd2 are kept open. In this state, the video signal line driver XDR outputs a video signal to the video signal line DL. In other words, the video signal line driver XDR makes a write current I_{sig} flow from the first power supply terminal ND1 to the video signal line DL. After a certain time period has elapsed, the switches SWb, SWc and SWd3 are opened to terminate the second write period.

The second write operation sets the difference between the potential V₅ of the node ND5 and the potential V_{dd} of the first power supply terminal ND1 at a value equal to the gate-to-source voltage of the drive control element DR when it allows the write current I_{sig}(m) to flow. Therefore, letting the potential V₅ of the node ND5 be V_{g}(m), the potential V₄ of the node ND4 can be expressed as the above equation (4).

In the effective display period following the second write period, the switches SWa, SWd1 and SWd2 are closed. The switches SWb, SWc, and SWd3 are kept open.

When the switches SWd1 and SWd2 are closed, the potential V₅ of the node ND5 is set equal to the sum of the potential V₃ of the node ND3 and the inter-electrode voltage VC1 expressed as the equation (3). As described above, since the potential V₃ is equal to the potential V₄ expressed as the equation (4), the potential V₅ of the node ND5 can be expressed as the above equation (7). Consequently, during the effective display period, the drive current I_{drv}(m) expressed as the equation (8) flows through the organic EL element OLED. The organic EL element OLED emits light at luminance corresponding to the magnitude of the drive current I_{drv}(m).

As apparent from this, according to the present embodiment, it is possible to set the magnitude of the drive current I_{drv} at a value [C_{b}/(Cₐ+C_{b})]² times the magnitude of the write current I_{sig}. Therefore, when the capacitances Cₐ and C_{b} are set appropriately, a gray level within the low gray level range can be display without significantly reduce the magnitude of the write current I_{sig}. Consequently, according to the present embodiment, each gray level within the low gray level range can be displayed with a high degree of reproducibility.

The capacitances of the capacitors C1 and C3 may be different from each other. In this case, although the relation between the magnitudes of the drive current I_{drv} and the write current I_{sig} deviates from the proportional relation, substantially the same effect as that described above can be attained.

A reset period may be provided before the write periods. For example, a reset operation described below may be executed prior to the first write operation.

The reset operation includes closing the switch SWc. The switches SWa, SWd1 and SWd2 are kept closed, and the switches SWb and SWd3 are kept open. The potential V₅ of the node N5 set by the reset operation reflects the characteristics of the drive control element DR and organic EL element OLED.

Note that the reset operation individually controls the switching operation of the switch SWb and the switching operation of the switch SWd3. When such a control is to be executed, additional scan signal lines are necessary.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising pixels arranged in a matrix, and video signal lines arranged correspondently with columns which the pixels form, each of the pixels comprising:
a drive control element which includes a control terminal, a first terminal connected to a first power supply terminal, and a second terminal outputting a current at a magnitude corresponding to a voltage between the control terminal and the first terminal;
a display element which includes a first electrode, a second electrode connected to a second power supply terminal, and an active layer interposed between the first and second electrodes;
an output control switch connected between the second terminal and the first electrode;
a switch group which is capable of switching between a first state that the second terminal, the control terminal, and the video signal line are connected to one another and a second state that the second terminal, the control terminal, and the video signal line are disconnected from one another;
first to third capacitors; and
first to third switches, the first switch, the first capacitor, the second switch, and the second capacitor being connected in series between the control terminal and a constant-potential terminal in this order, and the third switch and the third capacitor being connected in series between the control terminal and an electrode of the second capacitor to which the second switch is connected.

2. The display according to claim 1, wherein capacitances of the first and third capacitors are equal to each other.

3. The display according to claim 1, further comprising first to fourth scan signal lines arranged correspondently with rows which the pixels form,
wherein the output control switch includes a field-effect transistor whose gate is connected to the first scan signal line,
wherein the switch group comprises a selector switch which is connected between the second terminal and the video signal line and includes a field-effect transistor whose gate is connected to the fourth scan signal line, and a diode-connecting switch which is connected between the second terminal and the control terminal and includes a field-effect transistor whose gate is connected to the second scan signal line,
wherein the first switch includes a field-effect transistor whose gate is connected to the third scan signal line,
wherein the second switch includes a field-effect transistor whose gate is connected to the third scan signal line,
wherein the third switch includes a field-effect transistor whose gate is connected to the fourth scan signal line.

4. The display according to claim 1, wherein each of the pixels further comprises:
a fourth capacitor; and
fourth and fifth switches, the fourth capacitor and the fourth switch being connected in series between the constant-potential terminal and an electrode of the first capacitor to which the second switch is connected, and the second capacitor being connected to the constant-potential terminal via the fifth switch.

5. The display according to claim 4, wherein capacitances of the first and third capacitors are equal to each other, and capacitances of the second and fourth capacitors are equal to each other.

6. The display according to claim 4, further comprising first to sixth scan signal lines arranged correspondently with rows which the pixels form,
wherein the output control switch includes a field-effect transistor whose gate is connected to the first scan signal line,
wherein the switch group comprises a selector switch which is connected between the second terminal and the video signal line and includes a field-effect transistor whose gate is connected to the second scan signal line, and a diode-connecting switch which is connected between the second terminal and the control terminal and includes a field-effect transistor whose gate is connected to the third scan signal line,
wherein the first switch includes a field-effect transistor whose gate is connected to the fourth scan signal line,
wherein the second switch includes a field-effect transistor whose gate is connected to the first scan signal line,
wherein the third switch includes a field-effect transistor whose gate is connected to the second scan signal line,
wherein the fourth switch includes a field-effect transistor whose gate is connected to the fifth scan signal line, and
wherein the fifth switch includes a field-effect transistor whose gate is connected to the sixth scan signal line.

7. The display according to claim 1, wherein the constant-potential terminal is connected to the first power supply terminal.

8. The display according to claim 1, wherein the display element is an organic EL element.

9. An array substrate comprising pixel circuits arranged in a matrix, and video signal lines arranged correspondently with columns which the pixel circuits form, each of the pixel circuits comprising:
a drive control element which includes a control terminal, a first terminal connected to a power supply terminal, and a second terminal outputting a current at a magnitude corresponding to a voltage between the control terminal and the first terminal;
a pixel electrode;
an output control switch connected between the second terminal and the pixel electrode;
a switch group which is capable of switching between a first state that the second terminal, the control terminal, and the video signal line are connected to one another and a second state that the second terminal, the control terminal, and the video signal line are disconnected from one another;
first to third capacitors; and
first to third switches, the first switch, the first capacitor, the second switch, and the second capacitor being connected in series between the control terminal and a constant-potential terminal in this order, and the third switch and the third capacitor being connected in series between the control terminal and an electrode of the second capacitor to which the second switch is connected.

10. The array substrate according to claim 9, wherein capacitances of the first and third capacitors are equal to each other.

11. The array substrate according to claim 9, further comprising first to fourth scan signal lines arranged correspondently with rows which the pixel circuits form,
wherein the output control switch includes a field-effect transistor whose gate is connected to the first scan signal line,
wherein the switch group comprises a selector switch which is connected between the second terminal and the video signal line and includes a field-effect transistor whose gate is connected to the fourth scan signal line, and a diode-connecting switch which is connected between the second terminal and the control terminal and includes a field-effect transistor whose gate is connected to the second scan signal line,
wherein the first switch includes a field-effect transistor whose gate is connected to the third scan signal line,
wherein the second switch includes a field-effect transistor whose gate is connected to the third scan signal line,
wherein the third switch includes a field-effect transistor whose gate is connected to the fourth scan signal line.

12. The array substrate according to claim 9, wherein each of the pixel circuits further comprises:
a fourth capacitor; and
fourth and fifth switches, the fourth capacitor and the fourth switch being connected in series between the constant-potential terminal and an electrode of the first capacitor to which the second switch is connected, and the second capacitor being connected to the constant-potential terminal via the fifth switch.

13. The array substrate according to claim 12, wherein capacitances of the first and third capacitors are equal to each other, and capacitances of the second and fourth capacitors are equal to each other.

14. The array substrate according to claim 12, further comprising first to sixth scan signal lines arranged correspondently with rows which the pixel circuits form,
wherein the output control switch includes a field-effect transistor whose gate is connected to the first scan signal line,
wherein the switch group comprises a selector switch which is connected between the second terminal and the video signal line and includes a field-effect transistor whose gate is connected to the second scan signal line, and a diode-connecting switch which is connected between the second terminal and the control terminal and includes a field-effect transistor whose gate is connected to the third scan signal line,
wherein the first switch includes a field-effect transistor whose gate is connected to the fourth scan signal line,
wherein the second switch includes a field-effect transistor whose gate is connected to the first scan signal line,
wherein the third switch includes a field-effect transistor whose gate is connected to the second scan signal line,
wherein the fourth switch includes a field-effect transistor whose gate is connected to the fifth scan signal line, and
wherein the fifth switch includes a field-effect transistor whose gate is connected to the sixth scan signal line.

15. The array substrate according to claim 9, wherein the constant-potential terminal is connected to the power supply terminal.

16. A method of driving the display according to claim 1, comprising:
sequentially selecting rows which the pixels form;
sequentially executing first and second write operations on each of the pixels included in the selected row; and
executing a display operation on each of the pixels included in the non-selected row.

17. The method according to claim 16, wherein the first write operation includes connecting the second terminal to the control terminal while the output control switch and the third switch are opened and the first and second switches are closed,
wherein the second write operation includes supplying the video signal line with a current signal as a video signal while the output control switch and the first and second switches are opened, the second terminal, the control terminal and the video signal line are connected to one another, and the third switch is closed, and
wherein the display operation includes connecting the second terminal to the first electrode while the second terminal, the control terminal and the video signal line are disconnected from one another, the first and second switches are closed, and the third switch is opened.

18. The method according to claim 17, further comprising executing a reset operation on each of the pixels included in the selected row before executing the first and second write operations,
wherein the reset operation includes connecting the second terminal to the control terminal while the output control switch and the first and second switches are closed and the third switch is opened.

19. The method according to claim 16, wherein each of the pixels further comprises a fourth capacitor, and fourth and fifth switches, the fourth capacitor and the fourth switch being connected in series between the constant-potential terminal and an electrode of the first capacitor to which the second switch is connected, and the second capacitor being connected to the constant-potential terminal via the fifth switch,
wherein the first write operation includes connecting the second terminal to the control terminal while the output control switch and the second, third and fifth switches are opened and the first and fourth switches are closed,
wherein the second write operation includes supplying the video signal line with a current signal as a video signal while the output control switch and the first, fourth and fifth switches are opened, the second terminal, the control terminal and the video signal line are connected to one another, and the third and fifth switches are closed, and
wherein the display operation includes connecting the second terminal to the first electrode while the second terminal, the control terminal and the video signal line are disconnected from one another, the first, second and fifth switches are closed, and the third and fourth switches are opened.

20. The method according to claim 19, further comprising executing a first reset operation and/or a second reset operation on each of the pixels included in the selected row before executing the first and second write operations,
wherein the first reset operation includes connecting the second terminal to the control terminal while the output control switch and the first and fourth switches are closed and the second, third and fifth switches are opened, and
wherein the second reset operation includes connecting the second terminal to the control terminal while the output control switch and the second and third switches are closed and the first, fourth and fifth switches are opened.
